(19) United States
(12) Patent Application Publication
(10) Pub. No.: US 2025/0245464 A1
(43) Pub. Date: Jul. 31, 2025

(54) METASTABLE METAL PARTICLES AS PHYSICALLY-TIMED KEYS

(71) Applicant: North Carolina State University, Raleigh, NC (US)

(72) Inventors: Martin Thuo, Raleigh, NC (US); Andrew Martin, Raleigh, NC (US); Aydin Aysu, Raleigh, NC (US)

(21) Appl. No.: 19/043,071

(22) Filed: Jan. 31, 2025

Related U.S. Application Data
(60) Provisional application No. 63/752,332, filed on Jan. 31, 2025.
(60) Provisional application No. 63/627,355, filed on Jan. 31, 2024.

(51) Int. Cl. G06K 19/06; B23K 26/352; B23K 103/08

(52) U.S. Cl. CPC G06K 19/06009; B23K 26/352; B23K 2103/08

(57) ABSTRACT

Various examples are provided related to physically-timed keys. In one example, a method to provide a physically-timed physical unclonable function key includes providing a grid of metastable metal particles on undercooled metal particles; and inducing particle coalescence and growth of individual metastable metal particles through photon stimulation thereby forming a point-based pattern in the grid of metastable metal particles. Each point in the grid of metastable metal particles can carry predefined information or bear a specified information density. The method can further include initiating a physical timer of the grid of metastable metal particles by application of an external mechanical perturbation thereby triggering a phase relaxation of the individual metastable metal particles.

### CROSS REFERENCE TO RELATED APPLICATIONS

This application claims priority to, and the benefit of, U.S. provisional application entitled “Metastable Metal Particles as Physically-Timed Keys” having Ser. No. 63/627,355, filed Jan. 31, 2024, and U.S. provisional application Ser. No. 63/752,332, filed Jan. 31, 2025, both of which are hereby incorporated by reference in their entireties.

### BACKGROUND

The benefits of Physical Unclonable Functions (PUFs) as an encryption technology are highly sought after. Current PUFs, however, still see severe lack of real-world applications due to fabrication complexity, high sensitivity and lack of long-term stability. Metals have yet to see their full potential as a physical information storage carrier, despite inherently carrying information through its compositional entropy due to phase change.

### SUMMARY

Aspects of the present disclosure are related to physically-timed keys. In one aspect, among others, a method comprises providing a grid of metastable metal particles on undercooled metal particles and inducing particle coalescence and growth of individual metastable metal particles through photon stimulation thereby forming a point-based pattern in the grid of metastable metal particles. In one or more aspects, each point in the grid of metastable metal particles can carry predefined information or can bear a specified information density. The specified information density can be distributed across one or more of size, tilt angle, degree of metastability, composition, layers, ratio of crystalline to amorphous phases, phase fractions, inter-spot distance, or spinodal decomposition patterns. The method can comprise initiating a physical timer of the grid of metastable metal particles by application of an external mechanical perturbation thereby triggering a phase relaxation of the individual metastable metal particles. The phase relaxation can decay at a predictable rate. The phase relaxation can define a time window of the physical timer. The photon stimulation can be provided by a tunable power laser diode. Power of the laser can determine information density at each spot of the grid of metastable metal particles. The power laser diode can be tunable in a range from 0.05 watts or greater.

In various aspects, the point-based pattern can comprise individual metastable metal particles having a plurality of sizes, heights, aspect ratios, or modulus. The point-based pattern can comprise individual metastable metal particles having a plurality of compositions. The undercooled metal particles can be disposed on a silicon substrate. In some aspects, the method can comprise securing a supply chain based at least in part upon the point-based pattern. The method can comprise securing a valuable product based at least in part upon the point-based pattern. The method can comprise ascertaining an origin of a product or an intermedial handler based at least in part upon variations in the point-based pattern. The method can comprise ascertaining handling conditions or conditions under which a product has been handled based at least in part upon variations in the point-based pattern. The conditions can comprise one or more of thermal exposure, light exposure, acoustic exposure, or mechanical stress exposure. The method can comprise securing a manufacturing process based at least in part upon the point-based pattern. The method of can comprise ascertaining a state of a manufacturing process based at least in part upon the point-based pattern. Forming the point-based pattern can generate a machine readable code.

In another aspect, a method comprises providing a grid of metastable metal particles derived from undercooled metal particles by inducing particle coalescence and growth of select undercooled metal particles through photo stimulation thereby forming a point-based pattern on the grid of metastable metal particles. In one or more aspects, each point in the grid of metastable metal particles can carry predefined information and/or can bear a specified information density. The specified information density can be distributed across one or more of size, tilt angle, degree of metastability, composition, layers, ratio of crystalline to amorphous phases, phase fractions, inter-spot distance, or spinodal decomposition patterns. The method can comprise using graph theory to define the characteristics of the spinodal decomposition patterns and using properties of the defined graphs to decipher time and the encryption key. An algorithm can be utilized to read, analyze and decrypt the graphs/networks derived from spinodal decomposition patterns.

In some or all aspects, the method can comprise mapping the spinodal decomposition pattern and translating them into networks (graphs) whose time-dependent characteristics can be interpreted based on graph theory. Properties of these graphs such as node centrality, average weighted degree, fractality, Ollivier-Ricci curvature, can be calculated from obtained images to establish time since the relaxation started. The generation of these graphs can be based on microscopy images of the surface or core of the metastable particles and can be read with an algorithm that then translates the graph characteristic as a time output or a binary response (confirmation or rejection) to a user. The method can comprise initiating a physical timer on the grid of metastable metal particles by application of an external perturbation thereby triggering phase relaxation of the individual metastable metal particles. The external perturbation can comprise a mechanical force, laser, electric field, magnetic field, acoustics, radiation, surface plasmons, cavitation, or chemical etching. The phase relaxation can decay at a predictable rate. The phase relaxation can define a time window of the physical timer. The photo stimulation can be provided by a tunable power laser. Power of the laser can determine information density at each spot of the grid of metastable metal particles. The power of the laser can be tunable in a range from 0.05 watts or greater.

In various aspects, the point-based pattern can comprise individual metastable metal particles having a plurality of sizes, heights, aspect ratios, or modulus. The point-based pattern can comprise individual metastable metal particles having a plurality of compositions. The undercooled metal particles can be disposed on i) a flexible substrate like plastics, paper, or gels, ii) a rigid substrate like silicon, metal, ceramic, or glass. In some aspects, the method can comprise securing a supply chain based at least in part upon the point-based pattern. The method can comprise securing a valuable product based at least in part upon the point-based pattern. The method can comprise ascertaining an origin of a product or an intermedial handler based at least in part upon variations in the point-based pattern. The method can comprise authenticating a product or brand. The method can comprise ascertaining handling conditions or conditions under which a product has been exposed to based at least in part upon variations in the properties of the point-based pattern or a singular authentication point in the large pattern. The conditions can be ascertained using the whole pattern characteristics or based on one or a portion of the particles that are set as the verification points based on either their composition or sensitivity of the relaxation dynamics to changes in pressure, temperature, light, acoustics, or radiation. The conditions can comprise one or more of thermal exposure, light exposure, acoustic exposure, radiation exposure, chemical exposure, or mechanical stress exposure. The method can comprise securing a manufacturing process based at least in part upon the point-based pattern. The method of can comprise ascertaining a state of a manufacturing process based at least in part upon the point-based pattern. Forming the point-based pattern can generate a machine-readable code. Spinodal decomposition patterns from relaxing particles can form a machine readable code.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A schematically illustrate an example of the photon-induced growth on undercooled metal particles, in accordance with various embodiments of the present disclosure.

FIG. 1B illustrates an example of a 3-dimensional grid with a complex design of physical keys, in accordance with various embodiments of the present disclosure.

FIG. 2A is a scanning electron microscopy (SEM) image showing an example of complex pattern printing with large variation of particle sizes, in accordance with various embodiments of the present disclosure.

FIG. 2B is a plot illustrating a 3D predictive plot showing an example of correlation between power, time and particle size, in accordance with various embodiments of the present disclosure.

FIG. 2C illustrates an example of a height profile of particles created with different aspect ratios, in accordance with various embodiments of the present disclosure.

FIG. 2D illustrates an example of a force profile of particles created with different moduli, in accordance with various embodiments of the present disclosure.

FIG. 3A illustrates an example of the increase of a particle's elastic modulus as the particle is physically perturbed and phase transition induced, in accordance with various embodiments of the present disclosure.

FIG. 3B are SEM images of an example of pre- and post-phase relaxed particle, in accordance with various embodiments of the present disclosure.

FIG. 3C illustrates an example of the calculated nucleation rates based on differences in material's liquid viscosity, in accordance with various embodiments of the present disclosure.

FIG. 4A illustrates an example of a printed pattern of “NCSU WOLFPACK!!” (SEM and height profile of the pattern), in accordance with various embodiments of the present disclosure.

FIG. 4B illustrates an example of a compounding entropy as decryption level increases, in accordance with various embodiments of the present disclosure.

FIG. 4C illustrates an example of the projection of increased entropy value as resolution increases, in accordance with various embodiments of the present disclosure.

FIG. 5 illustrates an example of how a traceable irreversible network evolves due to spinodal decomposition in a relaxing particle forming a secure multi-hierarchical trapdoor function whose origin is difficult to decipher without significant amount of information, in accordance with various embodiments of the present disclosure.

FIG. 6A illustrates an example of network analysis of phase separating model binary mixture system, in accordance with various embodiments of the present disclosure.

FIG. 6B illustrates an example of an application of network generation and network breakdown algorithm on spinodal decomposition image of BiSn metal surface, in accordance with various embodiments of the present disclosure.

FIG. 6C illustrates an example of time-dependent evolution in connectivity ratio of a mixture undergoing a spinodal decomposition, in accordance with various embodiments of the present disclosure.

FIG. 6D illustrates an example of time-dependent evolution of spinodal patterns, focusing on bismuth, from a laser grown BilnSn particle over a 24-hour period and their associated graphs, in accordance with various embodiments of the present disclosure.

### DETAILED DESCRIPTION

Disclosed herein are various examples related to physically-timed keys. The use of metastable state in metal particles as a pathway to store information with unique fingerprints akin to PUFs is introduced. This process utilizes a “living” metastable material that can provide a physical timer due to its triggerable phase change and multi-decryption pathway since the fabrication process is tunable in many different variables.

These coded metallic patterns can be fabricated through a low-energy, high-fidelity, facile methodology with multitudes of controllable variables, resulting in a high entropy system with multiple decryption pathways. Furthermore, due to the metastable state of the information container, a physical timer can be induced through external force, triggering phase relaxation with predictable decay rate from diffusion flux. This work displays a unique perspective and utilization of phase-changing metal particles as an encryption device. The benefits of using metallic system and a bottom-up process tackles problems that are currently limiting other PUF systems.

The metastable state allows for triggerable phase change to be induced to the system. This phase change can be activated through mechanical external stimuli which initiates a phase relaxation. This phase relaxation can be tracked and utilized as a physical timer to the fabricated encryption. Multi-variable decryption pathways through size, height, aspect ratio, composition and/or modulus create a high entropy space that can be accessed by user-choice. The versatility of this device is illustrated through the available decryption options. Reference will now be made in detail to the description of the embodiments as illustrated in the drawings, wherein like reference numbers indicate like parts throughout the several views.

The root-of-trust for security-critical applications includes a trusted source of identity and the root keys for encryption services. Traditionally, these are implemented by digitally writing into a non-volatile read-only memory or by One-Time-Programmable (OTP) fuses in hardware. A major drawback of these approaches is the difficulty of erasure-once the information is written, it is permanently stored in hardware even when the power is turned off.

Physical Unclonable Functions (PUFs) emerged as a technology to help address this drawback of conventional solutions. PUFs exploit the inherent and uncontrollable manufacturing variations that occur during semiconductor fabrication to derive a unique “fingerprint” for each individual device. These fingerprints, akin to human biometrics, are nearly impossible to duplicate, predict, or clone, even when the manufacturing process is well-understood. PUFs, in contrast to the conventional technique of permanent storage, offer an alternative approach: they generate keys on-the-fly and hence do not store them explicitly. This dynamic generation capability renders PUFs inherently resistant to a wide range of hardware attacks aimed at key extraction. Although PUFs have found uses in real-world applications, it still has problems such as noise sensitivity, limited endurance, vulnerability to modeling attacks, and limited response entropy. These drawbacks can be tackled by improving the PUF circuits or by post-processing techniques.

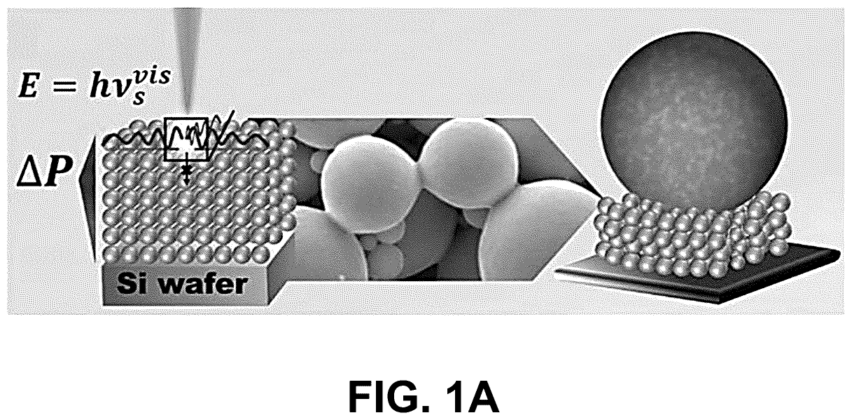

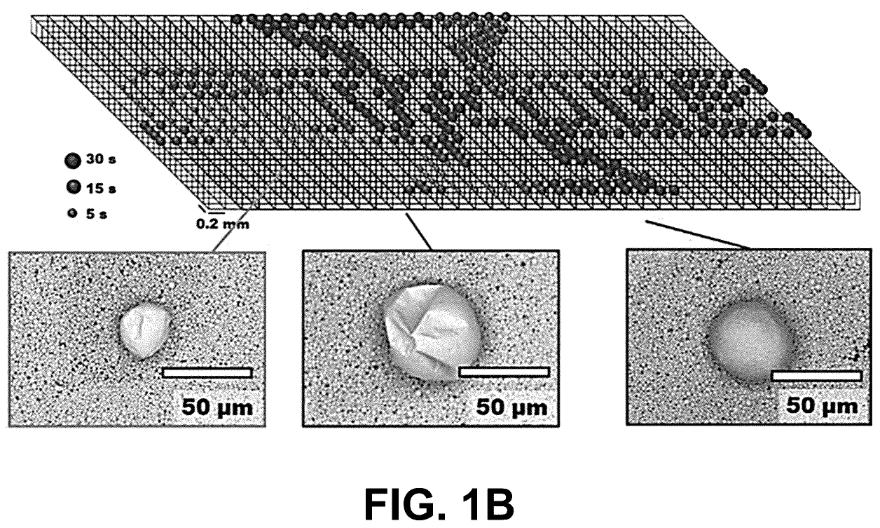

In this work, an alternative approach is proposed to establish a secure source of entropy through new advances in material science. Specifically, metastable phase transforming materials can be utilized as a physical encryption device. FIGS. 1A and 1B schematically illustrate an example of the utilization of metastable metal particles as physically-timed keys. The metastable frustrated thermodynamic state allows for a low-energy bottom-up process with high resolution as shown in FIG. 1A. Highly tunable processing parameters allows the design and fabrication of patterns with varying degrees of complexity as shown in FIG. 1B. Tunable, size, composition, aspect ratio, height and modulus create multiple decryption pathways with entropy scaling as resolution and number of considered variables increases. Furthermore, due to the metastable nature of these fabricated patterns, an important advantage of the present technology over conventional techniques and over PUFs is being physically timed. On-demand activation of these particles triggers a phase relaxation that is directly correlated to the diffusion flux of the metal atoms. Another advantage of the present technique over PUF solutions is not relying on manufacturing variations for entropy, which resolves the noise sensitivity and entropy issues.

A new approach is proposed to store information by controlling physical properties of each individual dot through localized photon triggers on an undercooled metal particle bed. A physically timed behavior is introduced by perturbing the metastable nature of the material, in which phase relaxation is utilized as a timer. The proposed system was prototyped on a metal bed deposited on silicon. The achievable entropy per unit area and the safe regions to operate can be quantified to eliminate errors in the writing procedure. Testing results show a high-resolution encryption process with up to 5 highly controllable variables for each individual point. Phase relaxation was demonstrated in the form of its mechanical property and can be used as a timer within a 24-hour margin. The multi-level decryption process was demonstrated through both visual and profilometry methods. The process was able to create significantly miniaturized encryption within the mm-scale, packing about 100 points with 0.1 mm resolution.

Background Trusted computing needs a root-of-trust that stores trusted identity information along with root keys for encryption. PUFs have been touted to replace the conventional techniques of permanent, memory-based storage that are vulnerable to physical readout attacks and other electrical attacks. PUFs can do so by erasing the secret information when the device is not used. But PUFs have several disadvantages that can limit their usage.

Barcode technology was developed to address the identity tracking problem. But barcode is essentially a track-and-trace method that cannot offer security since the barcode can be read by anyone and then be simply copied on a new tag. The more recent nanodot technology creates smaller thus harder-to-read identities but they still suffer from being permanent since there is no means to apply a controlled erasure after the information is written. The proposed approach can address the drawbacks of both technologies. Since the fabrication imperfections are not used, the present disclosure does not suffer from the PUF drawbacks while being resilient to simple readout techniques. This approach is superior to the barcode technologies because it can inherently and physically set a timer to the information written that will be automatically dissolved after the set time.

The present disclosure follows the well-established threat model of secure identifiers. It is assumes that the adversary can physically access the device and tries to read the information to replicate it in another instance. It is also assumed that the information could be valid for a limited amount of time, i.e., the system can have an expiration date after which the information obtained is no longer trusted. Other threats such as side-channel attacks or fault injection attacks are out of scope. They can be addressed with another layer of defense on top of the presently disclosed solution.

Approach. The presently disclosed process utilizes stabilized undercooled metal particles (BiSnIn, Field's metal) with a freezing temperature of −50° C. synthesized through a Shearing Liquids Into Complex Particles (SLICE) method. The nature of the deep undercooling of these metal particles allows them to be processed at room temperature without extraneous amounts of energy as opposed to traditional metal processing. Inducing photon stimuli on a particle bed through low power laser diodes (≤2 W) triggers a cascading event that initiates particle coalescence and growth through photothermal effect induced Marangoni flow at specific points where the laser is targeted. Furthermore, due to the rapid and self-containing nature of this process, the undercooled particles undergo partial phase transition, trapping them in a transient metastable state that still has a window for phase relaxation, thus creating a laser grown metastable particle. This mass transport event allows selective creation of point-based patterns with particles that can undergo phase relaxation when perturbed by further external forces.

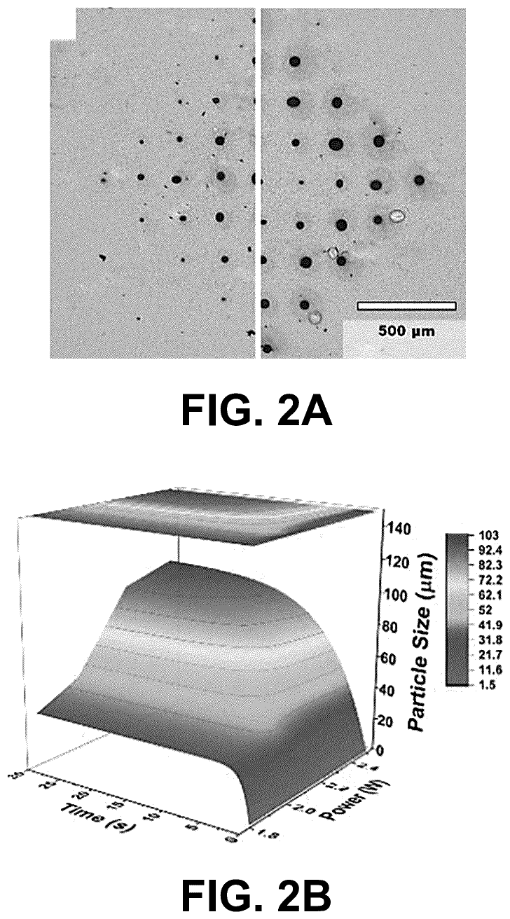

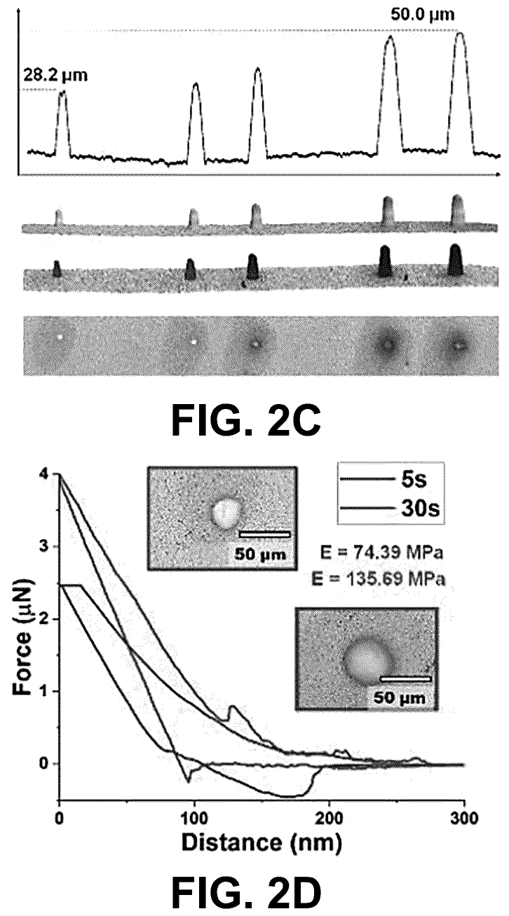

Fabrication of Highly Tunable Physical Key. Utilization of photons as the primary trigger allows extended control over the growth event through finely tuning the resolution and power density of the beam. With each particle only requiring <30 s of exposure time to completely grow, this process is easy to execute, rapid and facile. The power dependent nature of the growth process allows control of the size, composition, distance, aspect ratio and modulus of each individual particle, creating complex patterns with simple 3-dimensional grid. FIG. 2A is an SEM image showing an example of complex pattern printing with large variation of particle sizes.

This dependence on photon stimuli provides great tunability of the geometry of the grown particle as the energy density of the laser can be controlled (i.e., power, time, angular focus). FIG. 2B illustrates a 3D predictive plot showing an example of correlation between power, time and particle size. When the angular focus is altered during irradiation, particles with different aspect ratio can be created, adding complexity and variability to the physical key. FIG. 2C illustrates an example of a height profile of particles created with different aspect ratios. Furthermore, since the particle growth is coupled with partial phase transition, trapping them in a transient metastable state that still has window for phase relaxation due to the rapid and self-containing nature of this process. Depending on the irradiation time, the mechanical property of the grown particle is also altered beyond its dimension. FIG. 2D illustrates an example of a force profile of particles created with different modulus. Particles with lower irradiation time display a much softer force response with a Young's modulus (E) of 74.4 MPa. Whereas a particle irradiated for 30 s is significantly harder with E=135.7 MPa.

This degree of control provided by the photonic processing pathway allows for high variability in grown particles, thus also increasing the entropy on demand. Based on the need of the user, the information entropy stored within the encryption can be finely tuned utilizing size, height, modulus and composition.

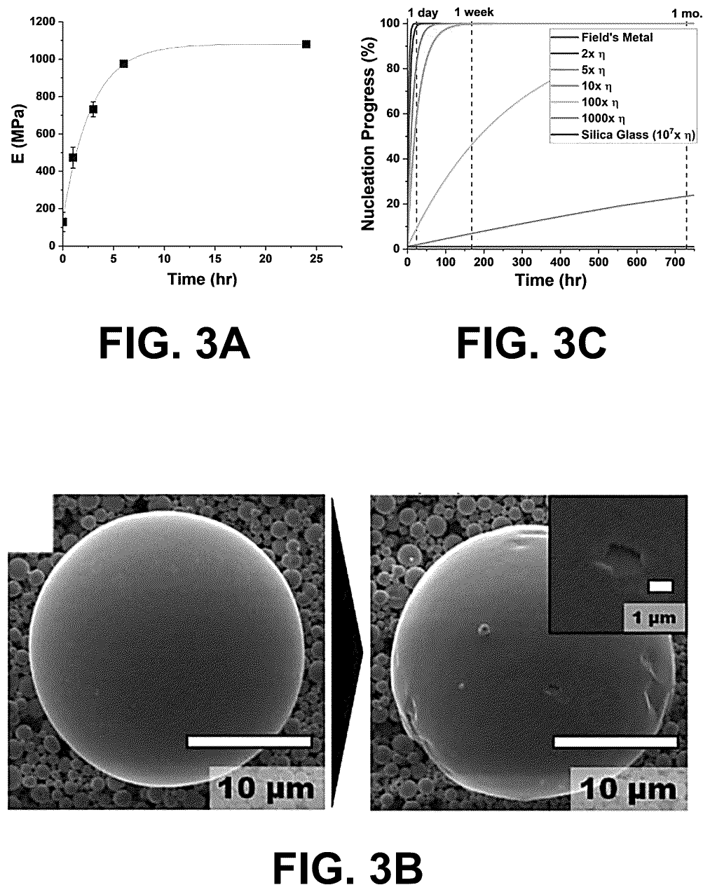

Physical Timer. The present disclosure utilizes the transient nature of these metastable metal particles as a physical timer. Despite its ambient stability due to its perfect particle isolation, phase transition can be triggered by inducing an external mechanical perturbation on the oxide shell. FIGS. 3A-3C illustrate a tracking particle's phase transition through its mechanical property shift. To trace this solidification process, its evolution in elastic modulus is utilized as a metric/timer. FIG. 3A illustrates the increase of a particle's elastic modulus as the particle is physically perturbed and induce phase transition. The unperturbed particle initially behaves as a soft solid solution (with low elastic modulus, ˜120 MPa). Upon activation, the particle's modulus increases exponentially until it reaches an asymptote, indicating that the particle has reached its ground, solid state (high elastic modulus, ˜1050 MPa). Beyond the mechanical property, the particle also sees a change in its form as the solidification induced a volumetric change, resulting in shrinkage and formation of defects on the exterior of these particles. FIG. 3B are SEM images of an example of pre- and post-phase relaxed particle. Due to the physical timer being linked to nucleation process, the timer itself can be tuned based on the viscosity of these particles as it is inversely proportional diffusion flux. Based on different viscosity, following an Arrhenius trend of nucleation and growth, the rate and therefore timer can be extended up to a whole year or more by changing the base material. FIG. 3C illustrates an example of the calculated nucleation rates based on differences in the material's liquid viscosity.

With these physical timers, the age of the encryption can be accurately tracked, and on-demand age acceleration can be triggered. The expiration time based on phase relaxation increases security as decryption of a certain message can be limited by a time window.

Results. As shown above, the photolithography fabrication method can create high information density printed patterns with variations in particle size, composition and/or shape at high resolution. A structure or a message can be written accordingly by creating a design in a 3-dimensional (3D) grid. FIG. 1B illustrates a 3D grid with a complex design of physical keys. Variations in size, aspect ratio, modulus and composition create an encryption with high compounding information entropy. Each variable added within the encryption escalates the analysis method, effort and time needed to achieve the decryption, where size analysis can take something as simple as a high-resolution light microscope and modulus analysis would take either a nano-indenter or an atomic force microscope.

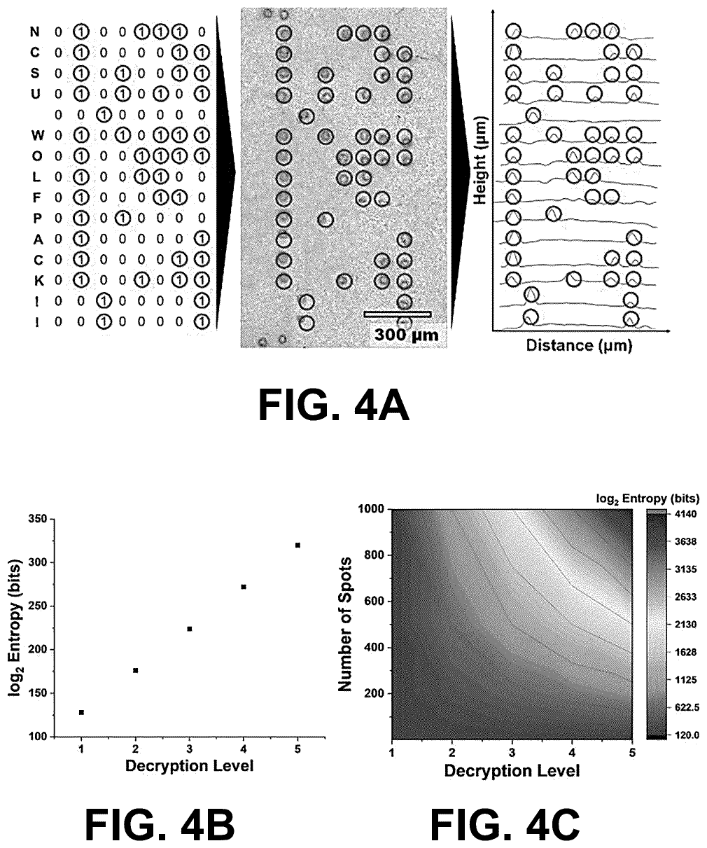

FIGS. 4A-4C illustrates examples of decryption pathways of a printed pattern. Using the described process, a pattern design was created based on a binary spelling of “NCSU WOLFPACK!!”. The pattern was created within an 8×16 grid with 2 timers on the top and bottom of the pattern. Each individual particle was created using 1.8 W of power with a 30 s exposure time. Each particle was created 0.1 mm apart, with the whole pattern spanning 0.7×2.5 mm. The resulting pattern can be identified from an image, or even just a height profile, dismissing the requirement of visual identification. FIG. 4A shows a printed pattern of “NCSU WOLFPACK!!” with an SEM and height profile of the pattern. With the information defined as a binary decision, the total entropy on a 128 particle is 2¹²⁸ bits. The printed particles have minimal deviation in size with an average radius of 21.04±1.84 μm out of 48 points as shown in FIG. 4A. Considering only particle radius, a global error rate of 10⁻⁹ can be achieved by placing the particle about 87 μm apart, with 10⁻¹¹ individual error rate. The deviations from intended points were also measured based on displacements in the x- and y-axis positions. The overall pattern has an average deviation of 16.13±8.04 μm in the x-axis and 10.65±7.15 μm in the y-axis. Considering the worst-case deviations on both x- and y-axis, a global error rate of 10⁻⁹ can still be achieved by placing the particles about 178 μm apart. FIG. 4A displays multiple decryption pathways on 3 different levels, particle existence, size, and height.

The multi-dimensional printing creates a unique cypher that can only be interpreted correctly in one direction, whilst having multiple alleyways of interpretations with increased cost of attack (see Table 1). For example, the message can be decrypted simply based on size using the naked eye or a magnifying glass (level 1), which has a total entropy of 128 bits. However, as the decryption technique increases with complexity (i.e., a naked eye to identify particle's existence, (level 1), microscope to identify particle size (level 2), profilometer to identify particle height (level 3), AFM to identify modulus and contour (level 4) and EDS to identify particle's elemental composition (level 5)) the overall compounding entropy and cost of attack increases. FIG. 4B illustrates an example of a compounding entropy as decryption level increases. FIG. 4C illustrates an example of the projection of increased entropy value as resolution increases.

TABLE 1
Compounding cost of attack for each individual variable.
Cost range determines resolution.

| Var. # | Property | Equipment | Cost |
|---|---|---|---|
| 1 | Existence | N/A | $0 |
| 2 | Size | Optical Microscope | $2,000-$5,000 |
| 3 | Height | Profilometer | $10,000-$20,000 |
| 4 | Modulus | AFM/Nanoindenter | $30,000-$50,000 |
| 5 | Composition | SEM-EDS | $100,000-$200,000 |

This entropy scales with the amount of particles that can be packed in a unit area, however, this scaling entropy is also balanced with the minimization of error rates for higher reliability. Each variable added has their own independent error rates and this number needs to be minimized below 10⁻⁹. Based on this compounding complexity, whilst from the eye of the designer it may have a finite information entropy, the value of entropy increases exponentially to infinite when it is seen from the perspective of the observer with no information.

As discussed, the benefits of PUFs as an encryption technology are highly sought after. Current PUFs, however, still see severe lack of real-world applications due to fabrication complexity, high sensitivity, and lack of long-term stability. Metals have yet to see their full potential as a physical information storage carrier, despite inherently carrying information through their compositional entropy, speciation, and/or phase change. Herein, the concept of utilizing metastable state in metal particles has been introduced as a pathway to store information with unique fingerprints akin to PUFs. These coded metallic patterns can be fabricated through a low-energy, high-fidelity, facile methodology with multitudes of controllable variables, resulting in a high entropy system with multiple decryption pathways. Furthermore, due to the metastable state of the information carrier, a physical timer can be induced through select external perturbation, triggering phase relaxation with a predictable decay rate related to diffusion-limited spinodal decomposition of the solid solution when the T₀ of the alloy is above ambient. A unique perspective and utilization of relaxation dynamics in phase-changing metal particles as an encryption device has been displayed. The benefits of using a metallic system and a bottom-up process tackle problems that are currently limiting other PUF systems.

Here, the utilization of metastable metal particles as physical encryption devices has been demonstrated. The present disclosure demonstrates that the highly tunable bottom-up fabrication process can create a “living” high entropy encryption pattern with multiple decryption pathways. This provides a fresh perspective on the fabrication of PUFs through the utilization of metastable metal particles as information carriers. The benefits and novelty of this methodology can be summarized as:

Highly tunable encryption patterns: Bottom-up, low-energy, non-destructive fabrication process allows for a highly tunable encryption patterns with multi-dimensional variability at high-resolution.

High stability and resilience: The utilization of metastable solid metal particles creates an inherent stability and resistance to outside interference as the fabricated patterns are highly robust.

Physical timer: Metastable state allows for triggerable phase change to be induced to the system. This phase change can be activated through mechanical external stimuli which initiates a phase relaxation. This phase relaxation can be tracked and utilized as a physical timer to the fabricated encryption.

Multi-decryption pathways: Multi-variable decryption pathway through size, height, aspect ratio, composition and modulus creates a high entropy space that can be accessed by user-choice. Versatility of this device is introduced through the available decryption options.

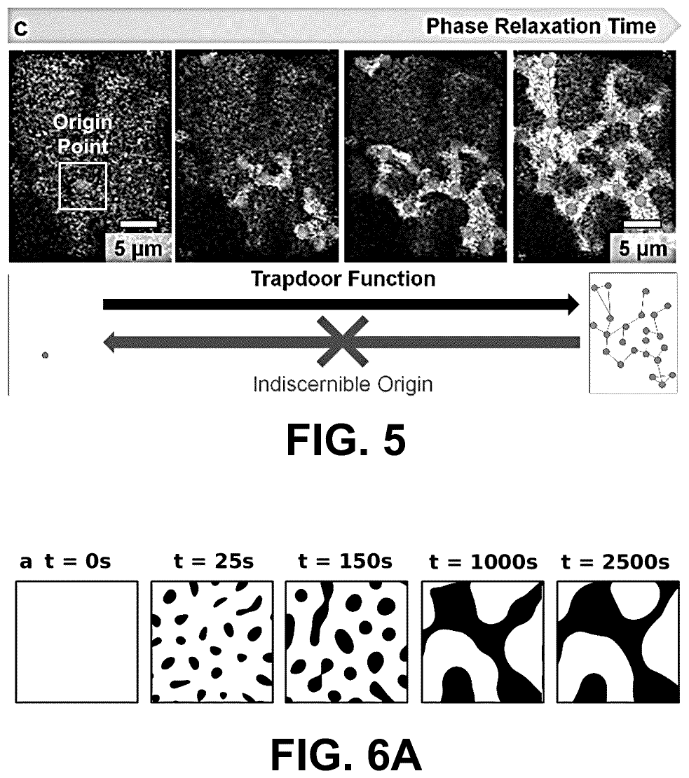

Trapdoor function embodiment: using associated spinodal decomposition patterns as a time-dependent trapdoor function whose origin cannot be deciphered without information on the alloy composition, particle size, processing wavelength, processing duration, time since activation, and decryption level/tool as discussed above. FIG. 5 illustrates how a traceable irreversible network evolves due to spinodal decomposition in a relaxing particle forming a secure multi-hierarchical trapdoor function whose origin is difficult to decipher without significant amount of information.

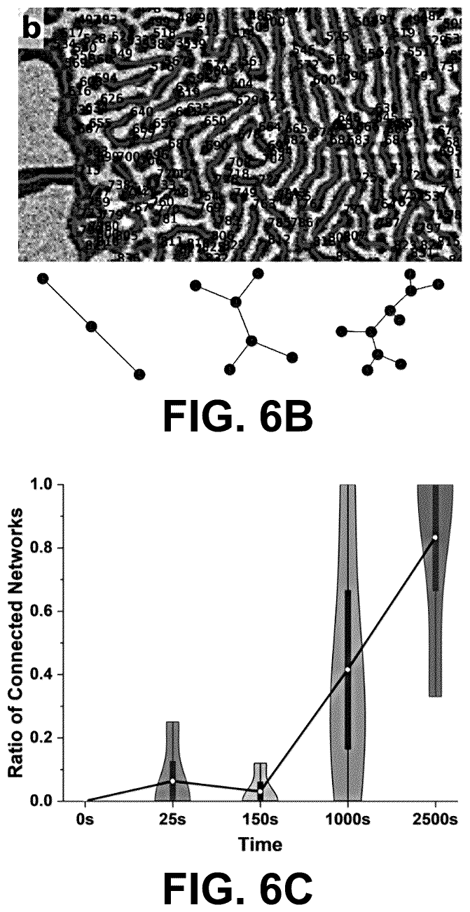

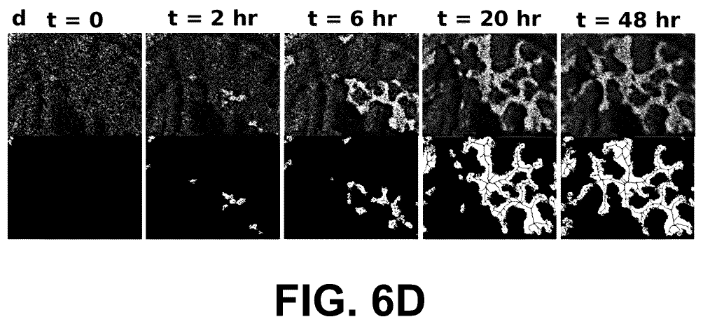

Graphs/Network embodiment: Application of graph theory and related algorithms to map evolving spinodal decomposition networks (FIG. 6B), using the graph characteristics to pinpoint the time evolved since activation of the particle(s) (FIGS. 6A and 6D). Deciphering uniqueness and time evolution based on network characteristics such as node connectedness (FIG. 6C). FIG. 6B illustrates application of network generation and network breakdown algorithm on spinodal decomposition image of BiSn metal surface. FIG. 6A illustrates network analysis of phase separating model binary mixture system and FIG. 6D illustrates an example of time-dependent evolution of spinodal patterns, focusing on bismuth, from a laser grown BilnSn particle over a 24-hour period and their associated graphs. Evolution in network properties can be captured as total number of nodes and edges, connection ratio, average degree, average closeness centrality, fractality, among other established network analysis parameters. FIG. 6C illustrates time-dependent evolution in connectivity ratio of a mixture undergoing a spinodal decomposition.

In some embodiments, the method entails a machine-readable code that utilizes protocols analogous to structuralGT, NetworkX or a vector graphic protocol to map the networks emanating from microscopy images of the relaxing particles. The code being able to use contrast to generate a network whose properties or characteristics are decoded using graph theory. The parameters generated form a cipher that affirms or denies the authenticity of the product, brand, manufacturing process, or the supply chain.

In some embodiments the method entails a machine learning algorithm that trains the underlying code to improve authentication efficiency and accuracy at various levels of security either as a primary of second level of security.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 0.5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e., one atmosphere).

Therefore, at least the following is claimed:

1. A method to provide a timed physical unclonable function key, comprising:
providing a grid of metastable metal particles on undercooled metal particles; and
inducing particle coalescence and growth of individual metastable metal particles through photon stimulation thereby forming a point-based pattern in the grid of metastable metal particles.

2. The method of claim 1, wherein each point in the grid of metastable metal particles carries predefined information or bears a specified information density.

3. The method of claim 2, wherein the specified information density is distributed across one or more of size, tilt angle, degree of metastability, composition, layers, ratio of crystalline to amorphous phases, phase fractions, inter-spot distance, or spinodal decomposition patterns.

4. The method of claim 1, further comprising initiating a physical timer of the grid of metastable metal particles by application of an external mechanical perturbation thereby triggering a phase relaxation of the individual metastable metal particles.

5. The method of claim 4, wherein the phase relaxation decays at a predictable rate.

6. The method of claim 5, wherein the phase relaxation defines a time window of the physical timer.

7. The method of claim 1, wherein the photon stimulation is provided by a tunable power laser diode.

8. The method of claim 7, wherein power of the laser determines information density at each spot of the grid of metastable metal particles.

9. The method of claim 7, wherein the power laser diode is tunable in a range from 0.05 watts or greater.

10. The method of claim 1, wherein the point-based pattern comprises individual metastable metal particles having a plurality of sizes, heights, aspect ratios, or modulus.

11. The method of claim 1, wherein the point-based pattern comprises individual metastable metal particles having a plurality of compositions.

12. The method of claim 1, wherein the undercooled metal particles are disposed on a silicon substrate.

13. The method of claim 1, comprising securing a supply chain based at least in part upon the point-based pattern.

14. The method of claim 1, comprising securing a valuable product based at least in part upon the point-based pattern.

15. The method of claim 1, comprising ascertaining an origin of a product or an intermedial handler based at least in part upon variations in the point-based pattern.

16. The method of claim 1, comprising ascertaining handling conditions or conditions under which a product has been handled based at least in part upon variations in the point-based pattern.

17. The method of claim 16, wherein the conditions comprise one or more of thermal exposure, light exposure, acoustic exposure, or mechanical stress exposure.

18. The method of claim 1, comprising securing a manufacturing process based at least in part upon the point-based pattern.

19. The method of claim 1, comprising ascertaining a state of a manufacturing process based at least in part upon the point-based pattern.

20. The method of claim 1, wherein forming the point-based pattern generates a machine readable code.
